(19) United States
(12) Patent Application Publication
(10) Pub. No.: US 2009/0132063 A1
(43) Pub. Date: May 21, 2009

(54) RECORDING ELEMENT SETTING METHOD, IMAGE RECORDING METHOD, AND DEVICE

(75) Inventors: Issei Suzuki, Kanagawa-ken (JP); Katsuto Sumi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/910,242

(22) PCT Filed: Mar. 28, 2006
(86) PCT No.: PCT/JP2006/306368

§ 371 Date: May 8, 2008

(30) Foreign Application Priority Data
Mar. 28, 2005 (JP) 2005-091623
May 31, 2005 (JP) 2005-159762

(51) Int. Cl. G06F 17/00; G05B 11/16

(52) U.S. Cl. 700/12; 700/90

(57) ABSTRACT

The locality characteristic data supplied from a locality characteristic data setting unit (87) is used to obtain the number of recording elements (40) constituting recording element groups constituting exposure heads (24a to 24j) which elements are to be controlled to OFF state. Mask data for setting a particular recording element (40) formed by the number of elements to OFF state is set and stored in a mask data memory (82). A predetermined recording element (40) is set to OFF state by the mask data. On the other hand, the recording element (40) which is not fixed to OFF state is controlled according to the image data so that a desired image is exposed/recorded on a substrate (F).

### TECHNICAL FIELD

The present invention relates to a recording component (element) setting method, an image recording method, and an image recording apparatus (device) for controlling a number of recording components arrayed along an image recording medium depending on image data to record an image on the image recording medium.

### BACKGROUND ART

FIG. 28 is a view illustrative of a process of manufacturing a printed wiring board. A substrate 2 with a copper foil 1 deposited thereon by evaporation or the like is prepared. A photoresist 3 made of a photosensitive material is pressed with heat against (laminated on) the copper foil 1. After the photoresist 3 is exposed to light according to a wiring pattern by an exposure apparatus, the photoresist 3 is developed by a developing solution. Then, the portion of the photoresist 3 which has not been exposed is removed. The copper foil 1 that is exposed by the removal of the photoresist 3 is etched away by an etching solution. Thereafter, the remaining photoresist 3 is peeled off by a peeling solution. As a result, a printed wiring board having the copper foil 1 left in the desired wiring pattern on the substrate 2 is manufactured.

There has been developed a spatial light modulator such as a digital micromirror device (DMD) or the like, for example, as the exposure apparatus for recording the wiring pattern on the photoresist 3 (see U.S. Pat. No. 5,132,723). The DMD comprises a number of micromirrors tiltably disposed in a grid-like array on SRAMs (memory cells). The micromirrors have respective surfaces with a highly reflective material such as aluminum or the like being evaporated thereon. When a digital signal representative of image data is written into SRAM cells, the corresponding micromirrors are tilted in a given direction depending on the digital signal, selectively turning on and off light beams and directing the turned-on light beams to the photoresist 3 to record a wiring pattern by exposure.

The light beams reflected by the respective micromirrors and led to the photoresist 3 may have different intensities, beam diameters, beam shapes, etc., depending on the location. On the substrate 2 where the wiring pattern is to be formed, the laminated state of the photoresist 3 may differ depending on the location due to irregularities of heating temperature and pressure, and chemical reaction rates may become irregular in chemical processes such as the developing process and the etching process. Due to localities caused by these irregularities, it may not be possible to form wiring patterns of desired line widths on the substrate 2.

### DISCLOSURE OF THE INVENTION

It is a general object of the present invention to provide a recording component setting method, an image recording method, and an image recording apparatus which are capable of correcting localities with ease and of recording a desired image highly accurately on an image recording medium.

A major object of the present invention is to provide a recording component setting method, an image recording method, and an image recording apparatus which are capable of correcting localities in view of the state of recording components or an image recording medium.

### BRIEF DESCRIPTION OF THE DRAWINGS

FIG. 1 is an external perspective view of an exposure apparatus according to an embodiment of the present invention;

FIG. 2 is a schematic view of an exposure head of the exposure apparatus according to the embodiment;

FIG. 3 is an enlarged fragmentary view showing a DMD employed in the exposure head shown in FIG. 2;

FIG. 4 is a view illustrative of an exposure recording process performed by the exposure head shown in FIG. 2;

FIG. 5 is a diagram showing the DMD of the exposure head shown in FIG. 2 and mask data set in the DMD;

FIG. 6 is a diagram showing the relationship between a recording position and an amount-of-light locality in the exposure apparatus according to the embodiment;

FIG. 7 is a diagram showing a line width recorded when the amount-of-light locality shown in FIG. 6 is not corrected;

FIG. 8 is a diagram showing a line width recorded when the amount-of-light locality shown in FIG. 6 is corrected;

FIG. 9 is a block diagram of a control circuit of the exposure apparatus according to the embodiment;

FIG. 10 is a flowchart of a process of setting mask data which is performed by the exposure apparatus according to the embodiment;

FIG. 11 is a diagram showing a test pattern recorded on a substrate by the exposure apparatus according to the embodiment;

FIG. 12 is a diagram showing the relationship between the positions of the test pattern shown in FIG. 11 and measured line widths;

FIG. 13 is a diagram showing the relationship between changes in the amount of light of a laser beam applied to the substrate and corresponding line width changes;

FIG. 14 is a diagram showing the relationship between the position of the substrate and the amount-of-light correction variables;

FIG. 15 is a diagram illustrative of the manner in which mask data are set using threshold data;

FIG. 16 is a diagram illustrative of the manner in which mask data are set using threshold data;

FIG. 17 is a diagram illustrative of the manner in which mask data are set by projecting recording components one-dimensionally;

FIG. 18 is a diagram illustrative of a halftone dot pattern recorded on a substrate by the exposure apparatus according to the embodiment;

FIG. 19 is a diagram illustrative of grayscale data as test data;

FIG. 20 is a diagram illustrative of a copper foil pattern formed on a substrate using the grayscale data shown in FIG. 19;

FIG. 21 is a diagram showing another test pattern recorded on a substrate by the exposure apparatus according to the embodiment;

FIG. 22 is a view showing an edge area formed along a direction in which a substrate is scanned;

FIG. 23 is a view showing an edge area formed along a direction perpendicular to a direction in which a substrate is scanned;

FIG. 24 is a diagram showing the relationship between amounts of change in the amount of light and in line width on photosensitive materials of different types;

FIG. 25 is a diagram showing the relationship between the position of the substrate and the line width on photosensitive materials of different types;

FIG. 26 is a diagram showing the relationship between the position of the substrate and the amount-of-light correction variables on photosensitive materials of different types;

FIG. 27 is a block diagram of a control circuit of an exposure apparatus according to another embodiment of the present invention; and

FIG. 28 is a view illustrative of a process of manufacturing a printed wiring board.

### BEST MODE FOR CARRYING OUT THE INVENTION

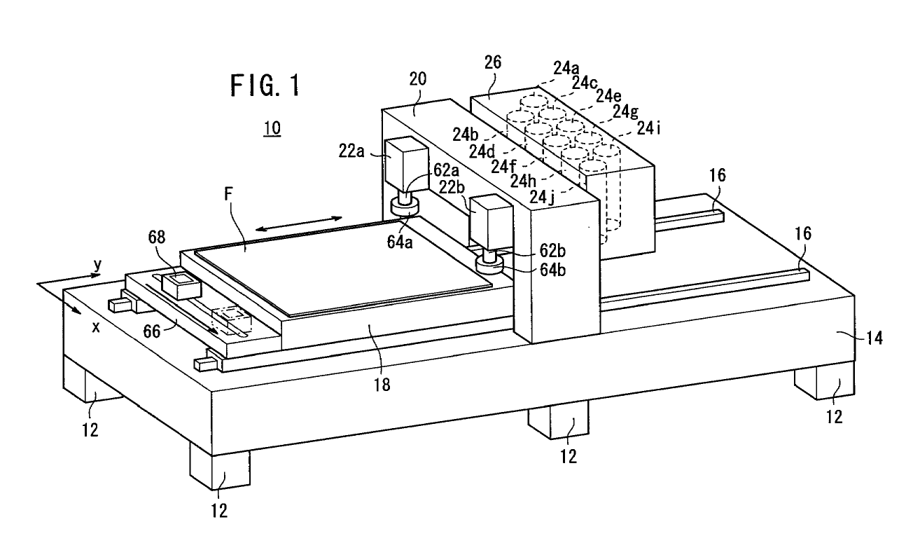

FIG. 1 shows an exposure apparatus 10 for performing an exposure process on a printed wiring board, etc., to which a recording component setting method, an image recording method, and an image recording apparatus according to an embodiment of the present invention are applied. The exposure apparatus 10 has a bed 14, which suffers very little deformations, supported by a plurality of legs 12, and an exposure stage 18 mounted on the bed 14 by two guide rails 16 for reciprocating movement in the directions indicated by the arrow. An elongate rectangular substrate F (mage recording medium) coated with a photosensitive material is attracted to and held on the exposure stage 18.

A portal column 20 is mounted centrally on the bed 14 over the guide rails 16. Two CCD cameras 22a, 22b are fixed to one side of the column 20 for detecting the position in which the substrate F is mounted with respect to the exposure stage 18. A scanner 26 having a plurality of exposure heads 24a through 24j positioned and held therein for recording an image on the substrate F by way of exposure is fixed to the other side of the column 20. The exposure heads 24a through 24J are arranged in two staggered rows in a direction perpendicular to the directions in which the substrate F is scanned (the directions in which the exposure stage 18 is movable). Flash lamps 64a, 64b are mounted on the CCD cameras 22a, 22b, respectively, by respective rod lenses 62a, 62b. The flash lamps 64a, 64b apply an infrared radiation to which the substrate F is insensitive, as illuminating light, to an image capturing area for the CCD cameras 22a, 22b.

A guide table 66 which extends in the direction perpendicular to the directions in which the exposure stage 18 is movable is mounted on an end of the bed 14. The guide table 66 supports thereon a photosensor 68 movable in the direction indicated by the arrow x for detecting the amount of light of laser beams L emitted from the exposure heads 24a through 24j.

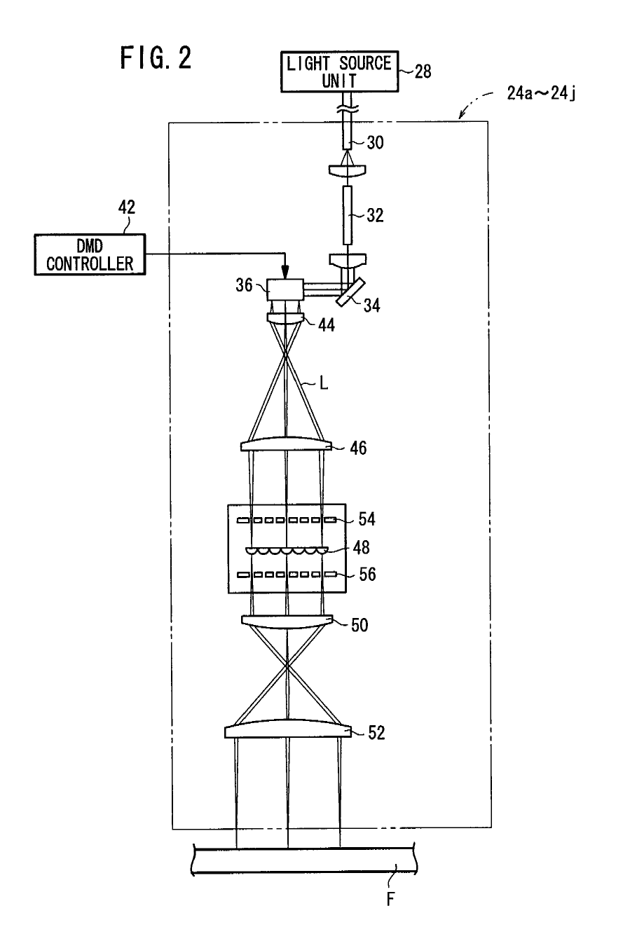

FIG. 2 shows a structure of each of the exposure heads 24a through 24j. A combined laser beam L emitted from a plurality of semiconductor lasers of light source unit 28 is introduced through an optical fiber 30 into each of the exposure heads 24a through 24j. A rod lens 32, a reflecting mirror 34, and a digital micromirror device (DMD) 36 are successively arranged on an exit end of the optical fiber 30 into which the laser beam L is introduced.

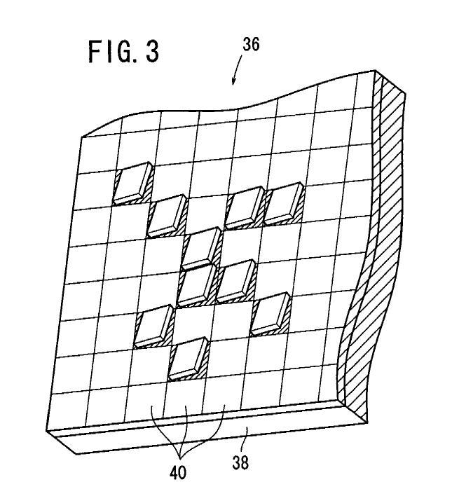

As shown in FIG. 3, the DMD 36 comprises a number of micromirrors 40 (recording components) that are swingably disposed in a matrix pattern on SRAM cells (memory cells) 38. A material having a high reflectance such as aluminum or the like is evaporated on the surface of each of the micromirrors 40. When a digital signal according to image recording data is written in the SRAM cells 38 by a DMD controller 42, the micromirrors 40 are tilted in given directions depending on the applied digital signal. Depending on how the micromirrors 40 are tilted, the laser beam L is turned on or off.

In the direction in which the laser beam L reflected by the DMD 36 that is controlled to be turned on or off is emitted, there are successively disposed first image focusing optical lenses 44, 46 of a magnifying optical system, a microlens array 48 having may lenses corresponding to the respective micromirrors 40 of the DMD 36, and second image focusing optical lenses 50, 52 of a zooming optical system. Microaperture arrays 54, 56 for removing stray light and adjusting the laser beam L to a predetermined diameter are disposed in front of and behind the microlens array 48.

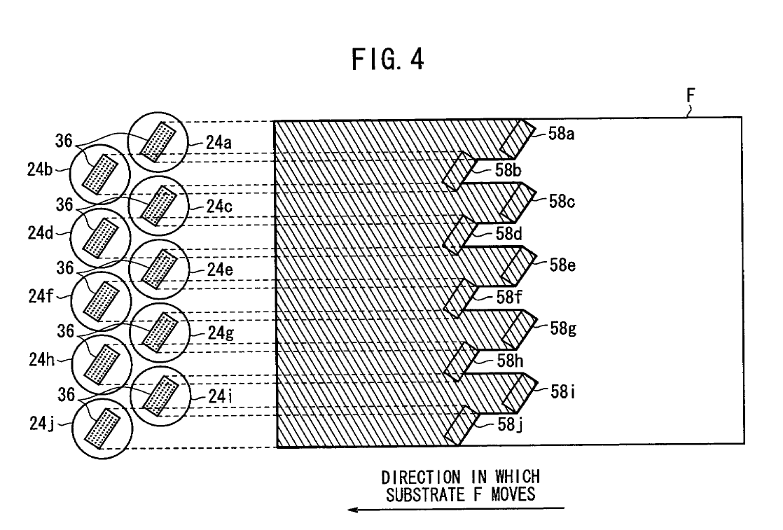

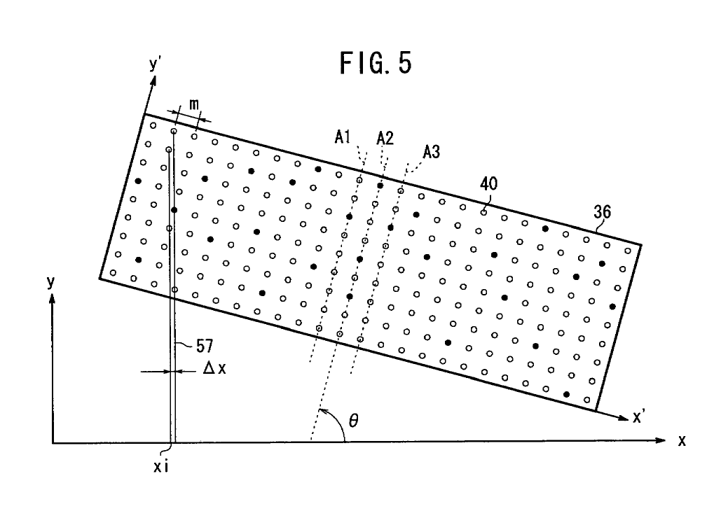

As shown in FIGS. 4 and 5, the DMDs 36 incorporated in the respective exposure heads 24a through 24j are inclined a predetermined angle to the direction in which the exposure heads 24a through 24J move, for achieving higher resolution. Specifically, the DMDs 36 that are inclined to the direction in which the substrate F is scanned (the direction indicated by the arrow y) reduce the interval Δx between the micromirrors 40 in the direction (the direction indicated by the arrow x) perpendicular to the direction in which the substrate F is scanned, to a value smaller than the interval m between the micromirrors 40 of the DMDs 36 in the direction in which they are arrayed (the direction indicated by the arrow x′), thereby increasing the resolution.

In FIG. 5, a plurality of micromirrors 40 are disposed on one scanning line 57 in the scanning direction (the direction indicated by the arrow y) of the DMDs 36. The substrate F is exposed to a multiplicity of images of one pixel by laser beams L that are guided to substantially the same position by these micromirrors 40. In this manner, amount-of-light irregularities between the micromirrors 40 can be averaged. To make the exposure heads 24a through 24J seamless, they are arranged such that exposure areas 58a through 58j which are exposed at a time by the respective exposure heads 24a through 24j overlap in the direction indicated by arrow x.

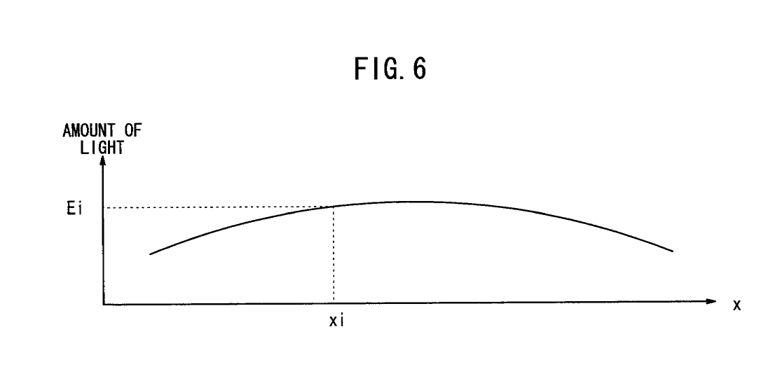

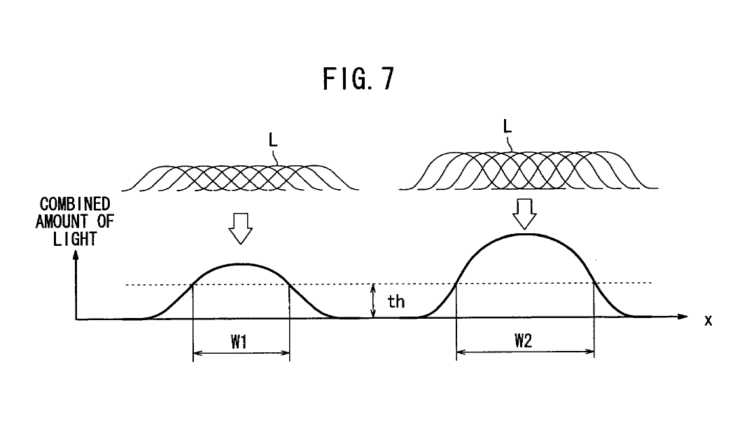

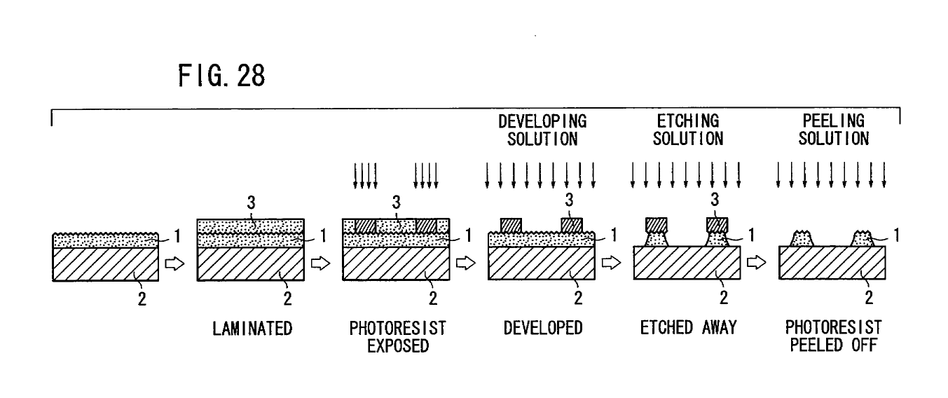

As shown in FIG. 6, the amount of light of the laser beam L that is guided to the substrate F by each of the micromirrors 40 of the DMDs 36 has a locality caused by the reflectance of the micromirrors 40 with respect to the direction indicated by the arrow x in which the exposure heads 24a through 24j are arrayed, and the recording characteristics of the optical systems. With such a locality, as shown in FIG. 7, when an image is recorded on the substrate F by laser beams L having a smaller combined amount of light which are reflected by a plurality of micromirrors 40 and when an image is recorded on the substrate F by laser beams L having a greater combined amount of light which are reflected by the micromirrors 40, the recorded images have respective different widths W1, W2 in the direction indicated by the arrow x as a threshold th beyond which the photosensitive material applied to the substrate F is sensitive in a predetermined state. When the exposed substrate F is processed by a developing process, an etching process, and a peeling process, as shown in FIG. 28, the widths of the images are also varied by the locality of the amount of light of the laser beams L such as photoresist lamination irregularities, developing process irregularities, etching process irregularities, and peeling process irregularities.

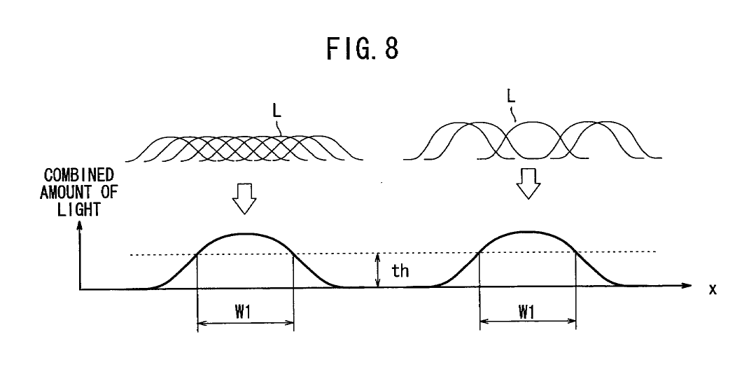

According to the present embodiment, in view of the above various factors responsible for the variations, the number of micromirrors 40 (the number of components) that are used to form one pixel of image on the substrate F can be controlled using mask data to produce images having a constant width W1 regardless of the positions in the direction indicated by the arrow x taking the various processes to the final peeling process into consideration, as shown in FIG. 8.

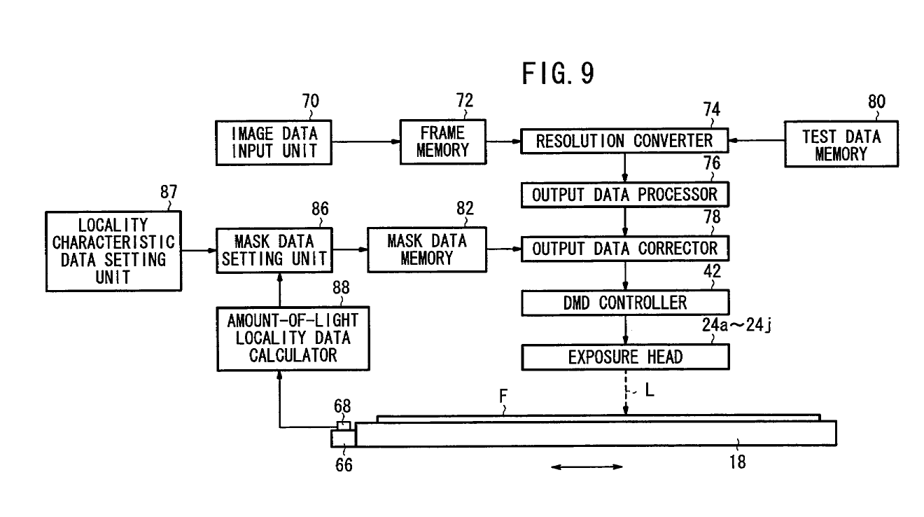

FIG. 9 shows in block form a control circuit of the exposure apparatus 10 having a function to perform such a control process.

The exposure apparatus 10 has an image data input unit 70 for entering image data to be recorded on the substrate F by exposure, a frame memory 72 for storing the two-dimensional image data, a resolution converter 74 for converting the resolution of the image data stored in the frame memory 72 into a higher resolution depending on the size and layout of the micromirrors 4 of the DMDs 36 of the exposure heads 24a through 24j, an output data processor 76 for processing the resolution-converted image data into output data to be assigned to the micromirrors 40, an output data corrector 78 for correcting the output data according to mask data, a DMD controller 42 (recording component control means) for controlling the DMDs 36 according to the corrected output data, and the exposure heads 24a through 24j for recording a desired image on the substrate F with the DMDs 36 that are controlled by the DMD controller 42.

A test data memory 80 for storing test data is connected to the resolution converter 74. The test data are data for recording by exposure a test pattern, which comprises a repetition of constant line widths and constant space widths, on the substrate F, and generating mask data based on the test pattern.

A mask data memory 82 (correction data storage means) for storing mask data is connected to the output data corrector 78. The mask data are data for specifying micromirrors 40 to be turned off at all times. The mask data are set by a mask data setting unit 86 (mask data setting means, particular recording component setting means). Connected to the mask data setting unit 86 are an amount-of-light locality data calculator 88 and a locality characteristic data setting unit 87 (locality characteristic data acquiring means). The amount-of-light locality data calculator 88 calculates amount-of-light locality data based on the amounts of light of the laser beams L detected by the photosensor 68. The locality characteristic data setting unit 87 sets therein locality characteristic data acquired from a test pattern recorded by exposure on the substrate F according to test data.

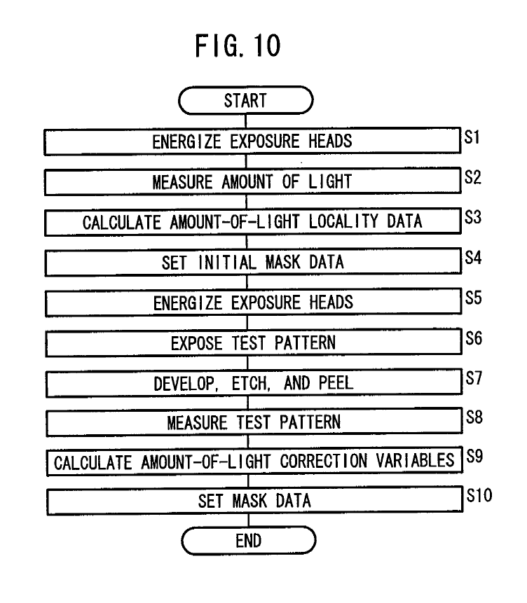

The exposure apparatus 10 according to the present embodiment is basically constructed as described above. A process of setting mask data will be described below with reference to a flowchart shown in FIG. 10.

First, the exposure stage 18 is moved to place the photosensor 68 beneath the exposure heads 24a through 24j. Thereafter, the exposure heads 24a through 24J are energized (step S1). At this time, the DMD controller 42 sets all the micromirrors 40 of the DMDs 36 to an on-state for guiding the laser beams L to the photosensor 68.

While moving in the direction indicated by the arrow x in FIG. 1, the photosensor 68 measures the amounts of light of the laser beams L emitted from the exposure heads 24a through 24j, and supplies the measured amounts of light to the amount-of-light locality data calculator 88 (step S2). Based on the amounts of light measured by the photosensor 68, the amount-of-light locality data calculator 88 calculates amount-of-light locality data of the laser beam L at each position xi (i=1, 2, . . . ) in the direction indicated by the arrow x, and supplies the calculated amount-of-light locality data to the mask data setting unit 86 (step S3).

Based on the supplied amount-of-light locality data, the mask data setting unit 86 generates initial mask data for making constant the amount Ei (i=1, 2, . . . ) of light of the laser beam L at each position xi (i=1, 2, . . . ) on the substrate F, and stores the initial mask data in the mask data memory 82 (step S4). The initial mask data are established as data for controlling some of a plurality of micromirrors 40 for forming one image pixel at each position xi on the substrate F, into an off-state according to the amount-of-light locality data in order to eliminate the amount-of-light locality shown in FIG. 6, for example. In FIG. 5, those micromirrors 40 that have been set to the off-state by the initial mask data are illustrated as black dots.

After the initial mask data have been established, the exposure stage 18 is moved to place the substrate F beneath the exposure heads 24a through 24j, and the exposure heads 24a through 24J are energized based on test data (step S5).

The resolution converter 74 reads test data from the test data memory 80, converts the resolution of the test data into a resolution corresponding to the micromirrors 40 of the DMDs 36, and supplies the resolution-converted test data to the output data processor 76. The output data processor 76 processes the resolution-converted image data into test output data representing signals for selectively turning on and off the micromirrors 40, and supplies the test output data to the output data corrector 78. The output data corrector 78 forcibly turns off those test output data for the micromirrors 40 which correspond to the initial mask data supplied from the mask data memory 82, and then supplies the corrected test output data to the DMD controller 42.

The DMD controller 42 selectively turns on and off the micromirrors 40 of the DMDs 36 according to the test output data that have been corrected by the initial mask data, thereby applying the laser beams L emitted from the light source unit 28 to the substrate F to record a test pattern by exposure (step S6). Since the test pattern is formed according to the test output data that have been corrected by the initial mask data, the test pattern is free of the amount-of-light locality of the laser beams L.

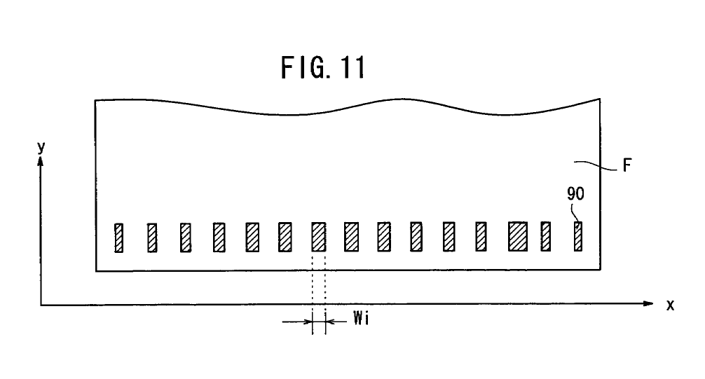

The developing process, the etching process, and the resist peeling process are performed on the substrate F with the test pattern recorded thereon by exposure, producing the substrate F with the test pattern remaining thereon (step S7). As shown in FIG. 11, for example, the test pattern comprises a plurality of rectangular test patterns 90 formed at respective positions xi (i=1, 2, . . . ) spaced along the direction indicated by the arrow x and having line widths Wi (i=1, 2, . . . ). In a locality-free ideal state, the test pattern is recorded based on test output data wherein the line widths Wi and space widths are constant regardless of the position xi.

If the beam diameters, the beam shapes, etc. of the laser beams L applied to the substrate F differ depending on the location or the processing processes for the substrate, including the developing process, suffer irregularities, then the line widths Wi (i=1, 2, . . . ) or the space widths of the test patterns 90 are not constant even though amount-of-light localities have been adjusted according to initial mask data.

The line widths Wi (i=1, 2, . . . ) of the test patterns 90 on the substrate F are measured (step S8), and the measured result is supplied to the locality characteristic data setting unit 87. The locality characteristic data setting unit 87 calculates amount-of-light correction variables ΔEi (i=1, 2, . . . ) (locality characteristic data) for correcting the supplied line widths Wi (i=1, 2, . . . ) into a minimum line width Wmin, and supplies the minimum line width Wmin to the mask data setting unit 86 (step S9).

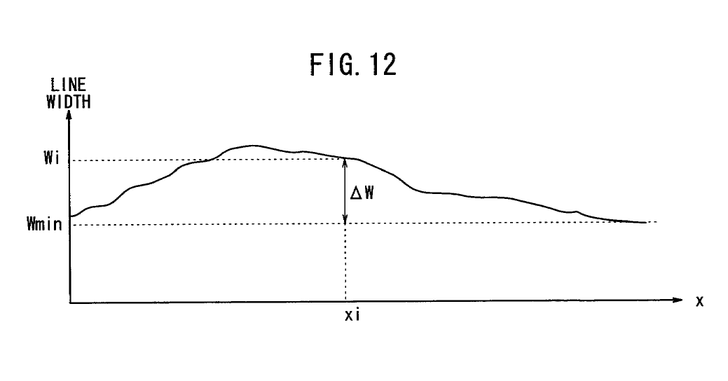

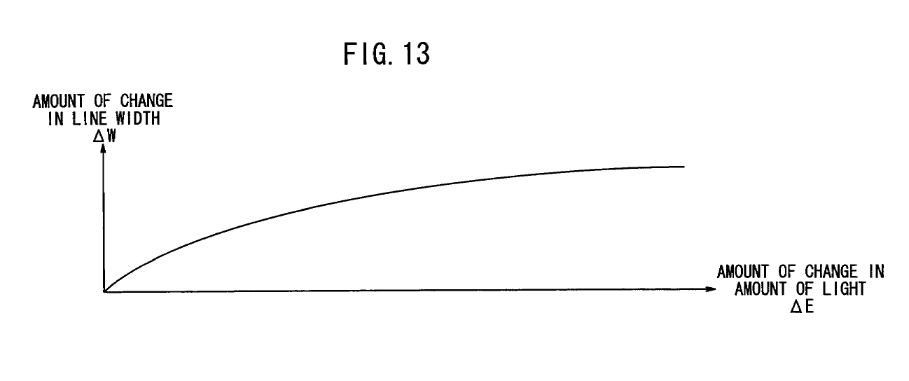

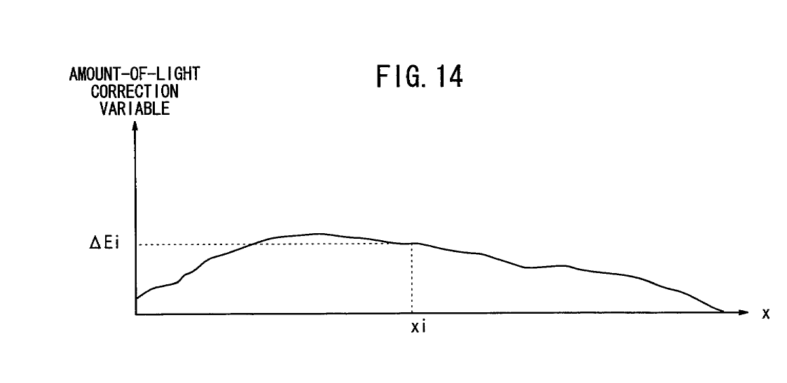

FIG. 12 shows the relationship between the positions xi (i=1, 2, . . . ) in the direction indicated by the arrow x and the measured line widths Wi (i=1, 2, . . . ). FIG. 13 shows the relationship between amounts ΔE of change in the amount of light of the laser beam L applied to the substrate F and corresponding amounts ΔW of change in the line widths. The relationship shown in FIG. 13 is determined in advance by an experiment, and the locality characteristic data setting unit 87 calculates an amount ΔE of change in the amount of light at each position xi for obtaining an amount ΔWi of change in the line width for correcting the measured line width Wi (i=1, 2, . . . ) into a minimum line width Wmin, as an amount-of-light correction variable ΔEi (i=1, 2, . . . ) (see FIG. 14).

Based on the calculated amount-of-light correction variable ΔEi (i=1, 2, . . . ), the mask data setting unit 86 adjusts the initial mask data set in step S4 to establish mask data (step S10). The mask data are established as data for determining micromirrors 40 to be set to the off-state among the micromirrors 40 that are used to form one pixel of image at each position xi (i=1, 2, . . . ) on the substrate F, according to the amount-of-light correction variables ΔEi (i=1, 2, . . . ). The established mask data are stored, in place of the initial mask data, in the mask data memory 82.

A process of establishing the mask data will be described in detail below.

Using the proportion of an amount-of-light correction variable ΔEi (i=1, 2, . . . ) to an amount Ei (i=1, 2, . . . ) of light at the time the output data are corrected with the initial mask data (see FIG. 6), and the number N of micromirrors 40 (a group of recording components) for forming an image in a predetermined range in the direction indicated by the arrow x, the number n of micromirrors 40 to be set to the off-state is calculated by:

n=N·ΔEi/Ei.

The mask data are established to set the n micromirrors 40, among the N micromirrors 40, to the off-state.

In the DMD 36 shown in FIG. 5, for example, a plurality of micromirrors 40 arrayed in the direction indicated by the arrow y′ are used as recording component groups (swathes A1, A2, A3, . . . ), and the amount-of-light correction variable ΔEi are associated respectively with the recording component groups. Then, mask data are established to turn off the micromirrors 40 of the recording component groups at equal decimated intervals k determined according to:

k=INT(N/n),

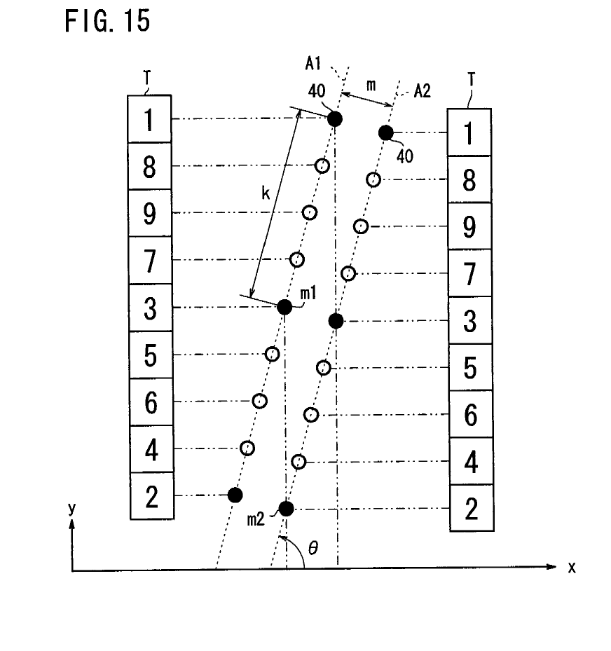

(see FIG. 15). INT represents a function for rounding down, rounding up, or rounding off the number of decimals of N/n.

When the micromirrors 40 of adjacent recording component groups (e.g., swathes A1, A2) expose pixels in substantially the same positions on the substrate F in the direction indicated by the arrow x, if the micromirrors 40 of the swathes A1, A2 which correspond to substantially the same pixels (m1, m2 in FIG. 15) are set to the off-state, then striped irregularities tend to be produced in the scanned direction of the recorded image (the direction indicated by the arrow y) in those areas.

Such a difficulty can be avoided by shifting the positions of the micromirrors 40 that are controlled into the off-state in the direction indicated by the arrow x between the swathes A1, A2. The process of shifting the positions of the micromirrors 40 that are controlled into the off-state may be performed if the positions in the direction indicated by the arrow x of the micromirrors 40 that are controlled into the off-state are judged as overlapping each other based on the angle θ by which the swathes A1, A2 are inclined to the direction indicated by the arrow x, the interval m between the micromirrors 40 in the direction indicated by the arrow x′, and the decimated interval k.

As shown in FIG. 15, the mask data may be established by associating threshold data T with the micromirrors 40 of the recording component groups, comparing the threshold data T with the number n of micromirrors 40 set to the off-state, and turning off those micromirrors 40 which correspond to the threshold data T that are smaller than n (T<n).

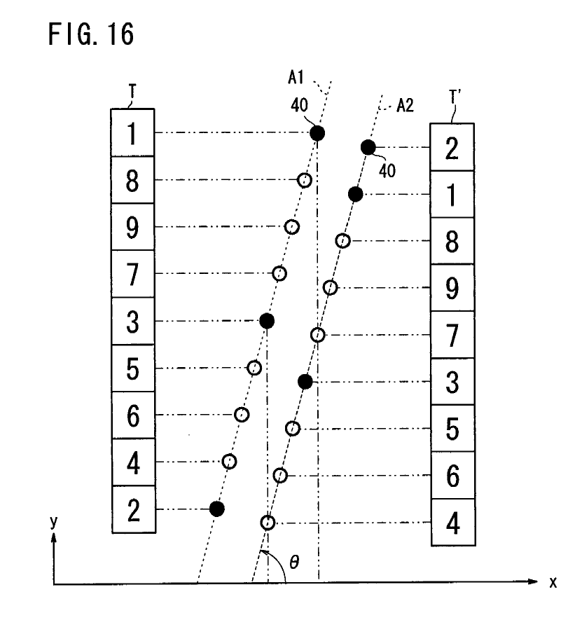

Alternatively, as shown in FIG. 16, the positions in the direction indicated by the arrow x of the micromirrors 40 that are controlled into the off-state are prevented from overlapping each other between the recording component groups by associating different threshold data T, T′ with the respective adjacent recording component groups.

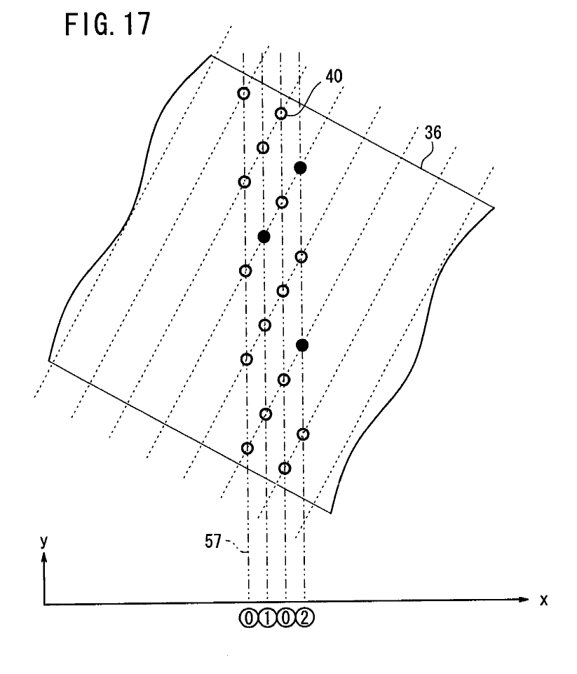

Further alternatively, as shown in FIG. 17, the micromirrors 40 of the DMD 36 which are arrayed in the direction indicated by the arrow y may be projected onto the axis along the direction indicated by the arrow x along scanning lines 57, and the numbers n of micromirrors 40 which are to be set to the off-state on the same scanning lines 57 (indicated by the numerals with O in FIG. 17) may be established based on the locality characteristic data. The positions of the micromirrors 40 which are to be set to the off-state may be set at equal intervals along the scanning lines 57 or may be set by comparing the threshold data T and the number n with each other, as shown in FIG. 15.

If some of the micromirrors 40 of the DMD 36 or the laser beams L are defective, then the micromirrors 40 corresponding to the defects may preferentially be set to the off-state for thereby avoiding a defect-dependent degradation of the image quality. In this case, for example, defective mirror data representing the micromirrors 40 which correspond to the defects may be prepared in advance, and the defective mirror data may be referred to for producing mask data. The defective micromirrors 40 include micromirrors 40 which cannot be controlled to on- or off-state, micromirrors 40 which fail to provide a desired amount of light on the exposed surface, etc.

If the micromirrors 40 to be turned off are positioned at equal intervals, as described above, then small areas of the substrate F can be exposed to a more substantially uniform level of energy than if the micromirrors 40 to be turned off are positioned at random intervals. For example, variations of the line widths of the lines that are formed so as to extend in the direction indicated by the arrow y can be reduced. The lines that are formed so as to extend in the direction indicated by the arrow x can have jaggies reduced.

After the mask data have thus been established, a desired wiring pattern is recorded by way of exposure on the substrate F.

First, image data representing a desired wiring pattern are entered from image data input unit 70. The entered image data are stored in the frame memory 72, and then supplied to the resolution converter 74. The resolution converter 74 converts the resolution of the image data into a resolution depending on the resolution of the DMDs 36, and supplies the resolution-converted image data to the output data processor 76. The output data processor 76 calculates output data representing signals for selectively turning on and off the micromirrors 40 of the DMDs 36 from the resolution-converted image data, and supplies the calculated output data to the output data corrector 78.

The output data corrector 78 reads the mask data from the mask data memory 82, corrects the on- and off-states of the micromirrors 40 that are represented by the output data, using the mask data, and supplies the corrected output data to the DMD controller 42.

The DMD controller 42 energizes the DMDs 36 based on the corrected output data to selectively turn on and off the micromirrors 40. The laser beams L emitted from the light source unit 28 and introduced through the optical fibers 30 into the exposure heads 24a through 24j are applied via the rod lenses 32 and the reflecting mirrors 34 to the DMDs 36. The laser beams L selectively reflected in desired directions by the micromirrors 40 of the DMDs 36 are magnified by the first image focusing optical lenses 44, 46, and then adjusted to a predetermined beam diameter by the microaperture arrays 54, the microlens arrays 48, and the microaperture arrays 56. Thereafter, the laser beams L are adjusted to a predetermined magnification by the second image focusing optical lenses 50, 52, and then guided to the substrate F. The exposure stage 18 moves along the bed 14, during which time a desired wiring pattern is recorded on the substrate F by the exposure heads 24a through 24j that are arrayed in the direction perpendicular to the direction in which the exposure stage 18 moves.

After the wiring pattern has been recorded on the substrate F, the substrate F is removed from the exposure apparatus 10, and then the developing process, the etching process, and the peeling process are performed on the substrate F. The amount of light of the laser beam L applied to the substrate F has been adjusted in view of the processes up to the final peeling process based on the mask data. Therefore, it is possible to obtain a highly accurate wiring pattern having a desired line width.

In the above embodiment, the test patterns 90 shown in FIG. 11 are recorded on the substrate F by way of exposure, and the mask data are determined by measuring the line widths Wi (i=1, 2, . . . ). However, mask data may be determined by measuring space widths between adjacent ones of the test patterns 90. If it is difficult to measure the line widths Wi (i=1, 2, . . . ) or the space widths highly accurately, then the densities of small areas established around the respective positions xi (i=1, 2, . . . ) of the test patterns 90 may be measured, and mask data may be determined from a distribution of the measured densities.

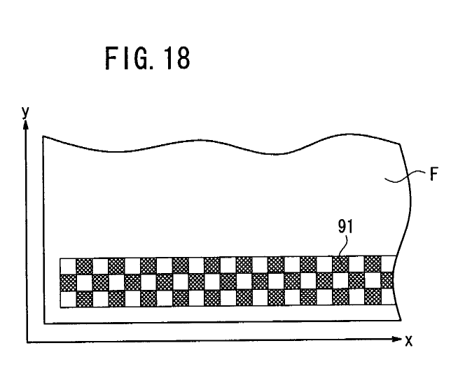

Instead of recording the test patterns 90 on the substrate F by way of exposure, as shown in FIG. 18, halftone dot patterns 91 having a predetermined halftone dot % may be recorded by way of exposure on the substrate F, and mask data may be determined by measuring halftone dot % or densities of the halftone dot patterns 91.

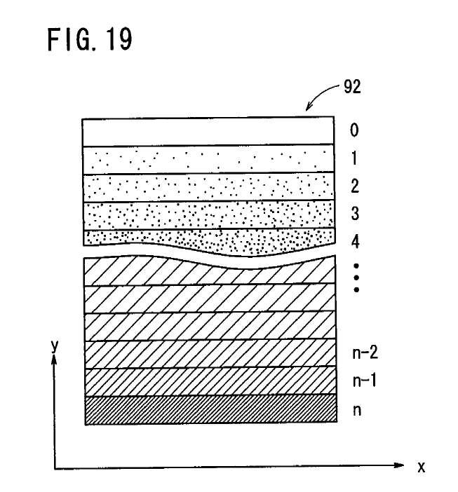

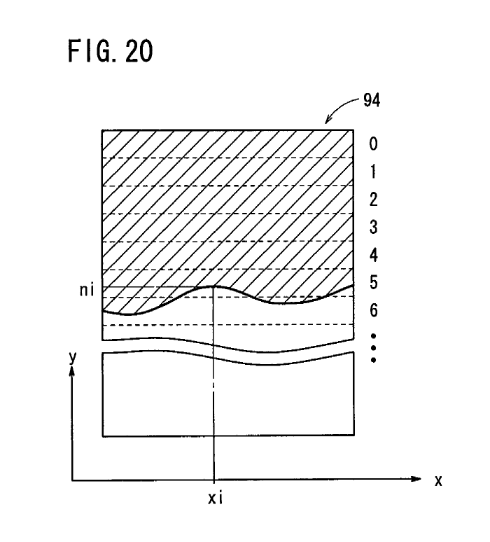

Gray scale data 92 in n (n=1, 2, . . . ) steps shown in FIG. 19 may be set as test data in the test data memory 80, and using the gray scale data 92, gray scale patterns for increasing amounts of light stepwise in the direction indicated by the arrow y on the substrate F may be recorded by way of exposure on the substrate F. Thereafter, the substrate F may be developed, and then, as shown in FIG. 20, the range of resist patterns 94 remaining on the substrate F may be measured, the number ni of corresponding steps of the gray scale data 92 at the positions xi (i=1, 2, . . . ) on the resist patterns 94 may be determined, and mask data may be determined based on the number ni.

Similarly for the test patterns 90, mask data may be determined by measuring resist patterns after they are developed.

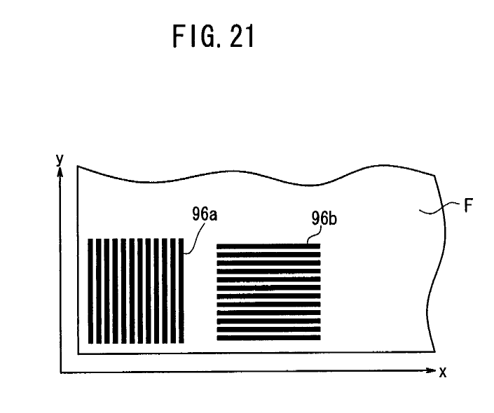

Alternatively, mask data may be determined by measuring the line widths of test patterns arrayed in two different directions. For example, as shown in FIG. 21, a test pattern 96a of parallel bars along the scanning direction (the direction indicated by the arrow y) and a test pattern 96b of parallel bars along the line perpendicular to the scanning direction (the direction indicated by the arrow x) may be recorded in each position xi on the substrate F, an amount-of-light correction variable may be calculated based on the average value of line widths of the test patterns 96a, 96b, and mask data may be determined. Using test patterns arranged in two different directions, it is possible to eliminate factors responsible for line width variations depending on the direction of the test patterns.

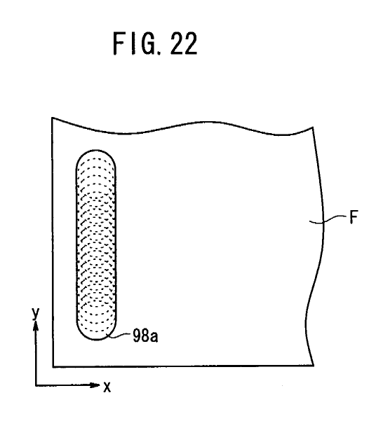

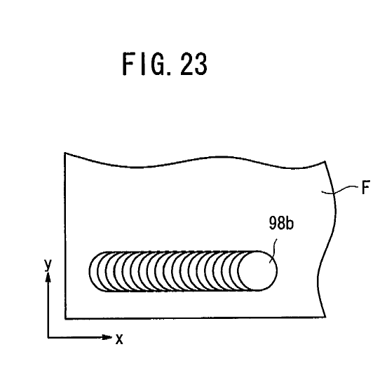

One factor that is responsible for varying the line widths may be that an edge of a test pattern is recorded differently in the scanning direction and the direction perpendicular to the scanning direction. Specifically, as shown in FIG. 22, an edge 98a of a test pattern in the direction in which the substrate F is scanned (the direction indicated by the arrow y), is recorded by a single spot or a plurality of spots of the laser beam L that move in the direction indicated by the arrow y, i.e., the direction in which the substrate F moves. On the other hand, as shown in FIG. 23, an edge 98b of a test pattern in the direction indicated by the arrow x is recorded by a plurality of spots of the laser beam L that do not move relatively to the substrate F. The difference as to how the edges 98a, 98b are recorded is possibly liable to develop different line widths. There is also a possibility of different line widths if the spots of the laser beam L are not of a circular shape.

Test patterns may be arranged in three or more directions, rather than the two directions described above. Test patterns that are inclined to the directions indicated by the arrows x, y may also be employed. A prescribed circuit pattern may be formed as a test pattern, and the circuit pattern may be measured to correct the amounts of light.

Alternatively, a plurality of mask data depending on the types of photosensitive materials applied to substrates F may be generated and stored in the mask data memory 82. Then, mask data corresponding to the type of the photosensitive material used may be selected, and the output data may be corrected thereby.

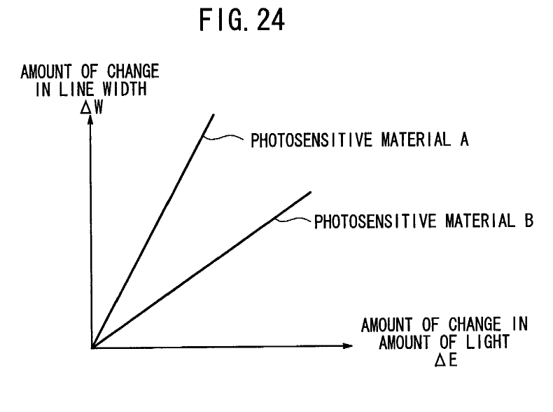

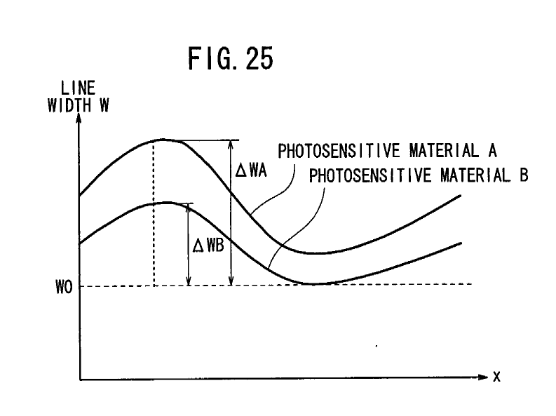

Specifically, as shown in FIG. 24, the relationship between an amount ΔE of change in the amount of light of the laser beam L applied to the substrate F and an amount ΔW of change in the line width, or the relationship between the amount of change in the beam diameter of the laser beam L and an amount ΔW of change in the line width, differs depending on the types of photosensitive materials A, B. The different relationships are caused by different gradation characteristics of the photosensitive materials A, B. As shown in FIG. 25, different line widths W may be produced even when a test pattern is recorded on the photosensitive materials A, B under the same conditions. In FIG. 24, the relationship between the amount ΔE of change in the amount of light and the amount ΔW of change in the line width is approximated by a straight line.

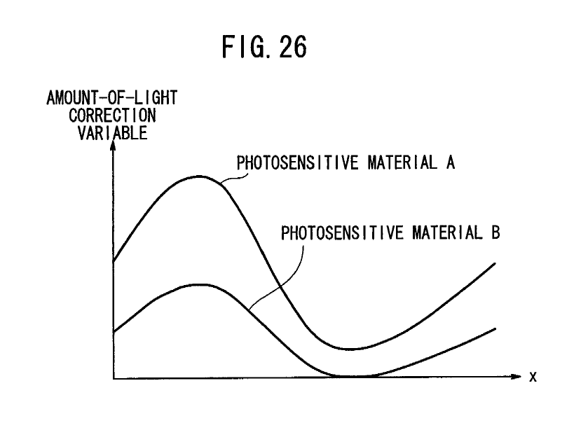

For recording patterns of the same line width regardless of the different characteristics of the photosensitive materials A, B, it is necessary to establish amount-of-light correction variables depending on the photosensitive materials A, B from the characteristic curves (FIG. 24) of the photosensitive materials A, B with respect to the relationship between the amount ΔE of change in the amount of light and the amount ΔW of change in the line width, and amounts of ΔWA, ΔWB (FIG. 25) of change in the line width from a reference line width W0 (e.g., a minimum value of the line width W) at each position xi for the respective photosensitive materials A, B. FIG. 26 shows an example of amount-of-light correction variables established for the photosensitive materials A, B.

According to the present embodiment, the mask data setting unit 86 sets mask data based on the amount-of-light correction variables that are determined for the photosensitive materials A, B, and stores the established mask data in the mask data memory 82. For exposing the substrate F to a desired wiring pattern, mask data corresponding to the type of the photosensitive material entered by the operator are read from the mask data memory 82, and output data supplied from output data processor 76 are corrected by the mask data. In this manner, a highly accurate wiring pattern free of line width variations can be recorded on the substrate F independently of the type of the photosensitive material.

In the above description, mask data are established in order to adjust localities with respect to the direction (the direction indicated by the arrow x) perpendicular to the scanning direction (the direction indicated by the arrow y) of the substrate F. If the mask data are established in a fixed manner, then striped irregularities may be produced in the direction indicated by the arrow y by the micromirrors 40 which are turned off at all times.

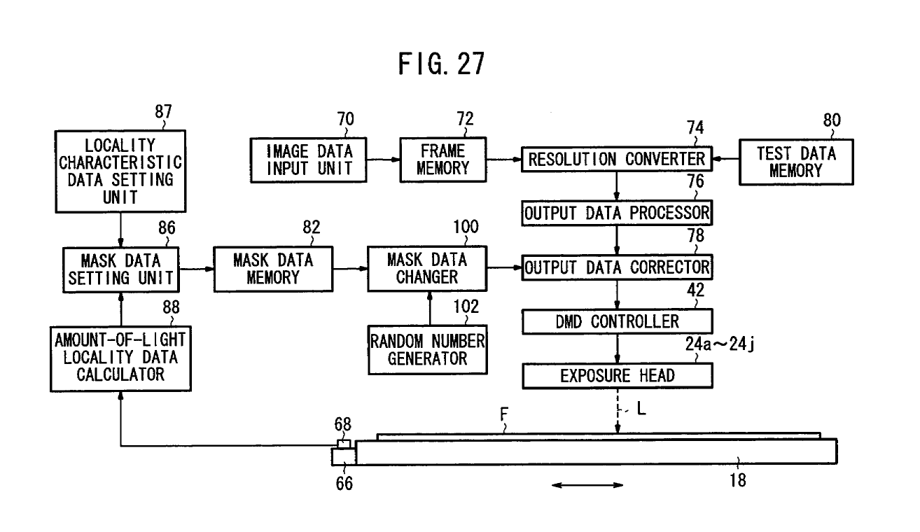

As shown in FIG. 27, a mask data changer 100 (mask data changing means, particular recording component switching means) may be disposed between the mask data memory 82 and the output data corrector 78 for changing the mask data read from the mask data memory 82 depending on the scanning position in the direction indicated by the arrow y, using random number data supplied from a random number generator 102, while keeping localities corrected in the direction indicated by the arrow x, for thereby lowering the visibility of striped irregularities in the direction indicated by the arrow y.

For example, the mask data changer 100 randomly changes the array of mask data supplied from the mask data memory 82 for turning off micromirrors 40 according to the random number data supplied from the random number generator 102 without changing the number of the micromirrors 40 that are turned off, with respect to each group of the micromirrors 40 of the swathes A1, A2, . . . shown in FIGS. 15 and 16 or each group of the micromirrors 40 on the scanning lines 57 shown in FIG. 17, depending on the scanning position in the direction indicated by the arrow y, and supplies the mask data of the changed array to the output data corrector 78. The output data corrector 78 corrects the output data using the supplied mask data, for thereby correcting the localities in the direction indicated by the arrow x and generating an image free of striped irregularities in the direction indicated by the arrow y.

Alternatively, mask data may be changed at predetermined time intervals to switch between the mask data depending on the movement of the scanning position, as a result. Further alternatively, a plurality of mask data may be prepared in advance, and the mask data may be switched depending on the scanning position (scanning time). The switching between the mask data may be realized by shifting the micromirrors 40 to be turned off in the direction indicated by the arrow x depending on the scanning position in the direction indicated by the arrow y.

In the above embodiment, the output data corrector 78 corrects the output data for controlling the on- or off-state of the micromirrors 40 with the mask data to control all the micromirrors 40 by forcibly turning off the micromirrors 40 that correspond to the mask data. On the other hand, the output data corrector 78 may keep the micromirrors 40 that correspond to the mask data fixedly turned off, and then control the on- or off-state of the remaining micromirrors 40 according to the output data.

Amount-of-light locality data and/or beam diameter locality data may be acquired as locality characteristic data, and mask data may be generated based on those data.

The exposure apparatus 10 may appropriately be used to expose a dry film resist (DFR) or a liquid resist in a process of manufacturing a multilayer printed wiring board (PWB), to form a color filter or a black matrix in a process of manufacturing a liquid crystal display (LCD), to expose a DFR in a process of manufacturing a TFT, and to expose a DFR in a process of manufacturing a plasma display panel (PDP), etc., for example. The present invention is also applicable to an image recording apparatus having an ink jet recording head. The present invention is also applicable to exposure apparatus for use in the field of printing and the field of photography.

1. A method of recording an image on an image recording medium (F) by controlling a plurality of recording components (40) depending on image data, comprising the steps of:
dividing the recording components (40) into recording component groups of adjacent recording components (40), and acquiring locality characteristic data of recording characteristics between the recording component groups;
determining the number of recording components (40) to be controlled into an off-state of the recording components (40) of each of said recording component groups to correct said locality characteristic data;
determining mask data for setting particular recording components (40), represented by said number of recording components (40) to be controlled into the off-state, with respect to each of said recording component groups; and
controlling said recording components (40) based on the image data for determining on- and off-states and said mask data for determining the off-state to record the image on said image recording medium (F).

2. A method according to claim 1, wherein said recording components (40) guide light beams to said image recording medium (F) depending on said image data to record the image thereon by way of exposure.

3. A method according to claim 1, wherein said image recording medium (F) is relatively scanned by said recording components (40).

4. A method according to claim 1, wherein said locality characteristic data are determined as correction data depending on the position of said recording components (40) for recording a test pattern in a desired recorded state on said image recording medium (F).

5. A method according to claim 1, wherein a threshold is established in association with each of the recording components (40) of said recording component groups, and compared with said number of recording components (40) to set said particular recording components (40).

6. A method according to claim 1, wherein said particular recording components (40) are set at substantially equal intervals in each of said recording component groups based on said number of recording components (40).

7. A method according to claim 6, wherein said recording components (40) of said recording component groups are arrayed on lines inclined a predetermined angle to a scanning direction of said image recording medium (F), and said lines are arrayed in a direction perpendicular to said scanning direction.

8. A method according to claim 6, wherein said recording components (40) which are arrayed two-dimensionally with respect to said image recording medium (F) are projected onto a one-dimensional axis, and said particular recording components (40), which is represented by said number of recording components (40), are set among the recording components (40) of said recording component groups projected onto respective positions on said one-dimensional axis.

9. A method according to claim 6, wherein said particular recording components (40), which is represented by said number (n) of recording components (40) to be controlled into the off-state, are set at an interval k expressed by:
k=INT(N/n) (INT represents a function for producing an integer)
among the N recording components (40) of said recording component groups.

10. A method according to claim 1, wherein the image is recorded at substantially a same point on said image recording medium (F) by said recording components (40) arrayed in a scanning direction of said image recording medium (F).

11. A method according to claim 10, wherein said recording components (40) of said recording component groups are arrayed on lines inclined a predetermined angle to a scanning direction of said image recording medium (F), and said lines are arrayed in a direction perpendicular to said scanning direction.

12. A method according to claim 11, wherein said recording components (40), which is represented by said number of recording components (40), are controlled into the off-state on each of said lines, so that positions at which said recording components (40) that are controlled into the off-state are projected onto a one-dimensional axis are held out of alignment with each other between said lines arrayed in the direction perpendicular to said scanning direction.

13. A method according to claim 1, wherein said mask data set for each of said recording component groups arrayed in a direction perpendicular to a scanning direction of said image recording medium (F) are changed depending on the movement of a recording position with respect to said scanning direction while said number of recording components is being maintained.

14. A method according to claim 1, wherein defective recording components (40) are preferentially selected as said particular recording components (40).

15. A method of recording an image on an image recording medium (F) by controlling a plurality of recording components (40) depending on image data, comprising the steps of:
acquiring locality characteristic data of recording characteristics due to said recording components (40);
setting particular recording components (40) to be controlled into an off-state in order to correct said locality characteristic data; and
controlling the recording components (40) which are not to be controlled into an off-state depending on the image data to record the image on said image recording medium (F);
wherein said step of setting particular recording components (40) comprises preferentially selecting defective recording components (40) as the recording components (40) to be controlled into the off-state.

16. A method according to claim 15, wherein the image is recorded at substantially a same point on said image recording medium (F) by said recording components (40) arrayed in a scanning direction of said image recording medium (F).

17. A method of recording an image on an image recording medium (F) by controlling a plurality of recording components (40) depending on image data, comprising the steps of:
acquiring locality characteristic data of recording characteristics due to said recording components (40);
setting particular recording components (40) to be controlled into an off-state in order to correct said locality characteristic data;
switching from said particular recording components (40) to other recording components depending on the movement of a recording position with respect to a scanning direction of said image recording medium (F); and
controlling the recording components (40) which are not to be controlled into an off-state depending on the image data to record the image on said image recording medium (F).

18. A method according to claim 17, wherein the image is recorded at substantially a same point on said image recording medium (F) by said recording components (40) arrayed in the scanning direction of said image recording medium (F).

19. A method of setting recording components in controlling a plurality of recording components (40) depending on image data to record an image on an image recording medium (F), comprising the steps of:
dividing the recording components (40) into recording component groups of adjacent recording components (40), and acquiring locality characteristic data of recording characteristics between the recording component groups;
determining the number of recording components (40) to be controlled into an off-state of the recording components (40) of each of said recording component groups to correct said locality characteristic data; and
determining mask data for setting particular recording components (40), represented by said number of recording components (40) to be controlled into the off-state, with respect to each of said recording component groups;
wherein said recording components (40) can be controlled based on the image data for determining on- and off-states and said mask data for determining the off-state.

20. A method according to claim 19, wherein said mask data set for each of said recording component groups arrayed in a direction perpendicular to a scanning direction of said image recording medium (F) are changed depending on the movement of a recording position with respect to said scanning direction while said number of recording components is being maintained.

21. A method according to claim 19, wherein defective recording components (40) are preferentially selected as said particular recording components (40).

22. A method of setting recording components in controlling a plurality of recording components (40) depending on image data to record an image on an image recording medium (F), comprising the steps of:
acquiring locality characteristic data of recording characteristics due to said recording components (40); and
setting particular recording components (40) to be controlled into an off-state in order to correct said locality characteristic data;
wherein said step of setting particular recording components (40) comprises preferentially selecting defective recording components (40) as the recording components (40) to be controlled into the off-state.

23. A method of setting recording components in controlling a plurality of recording components (40) depending on image data to record an image on an image recording medium (F), comprising the steps of:
acquiring locality characteristic data of recording characteristics due to said recording components (40);
setting particular recording components (40) to be controlled into an off-state in order to correct said locality characteristic data; and
switching from said particular recording components (40) to other recording components depending on the movement of a recording position with respect to a scanning direction of said image recording medium (F).

24. An apparatus for recording an image on an image recording medium (F) by controlling a plurality of recording components (40) depending on image data, comprising:
locality characteristic data acquiring means (87) for dividing the recording components (40) into recording component groups of adjacent recording components (40), and acquiring locality characteristic data of recording characteristics between the recording component groups;
mask data setting means (86) for setting mask data for controlling particular recording components (40) selected from said recording components (40) of said recording component groups into an off-state, in order to correct said locality characteristic data;
mask data storage means (82) for storing said mask data; and
recording component control means (42) for controlling said recording components (40) based on the image data for determining on- and off-states and said mask data for determining the off-state.

25. An apparatus according to claim 24, wherein said recording components (40) comprise exposure components for guiding light beams to said image recording medium (F) depending on said image data to record the image thereon by way of exposure.

26. An apparatus according to claim 25, wherein said exposure components make up a spatial light modulator for modulating a light beam depending on said image data and guiding the modulated light beam to said image recording medium.

27. An apparatus according to claim 26, wherein said spatial light modulator comprises a micromirror device (36) including a two-dimensional array of micromirrors having reflecting surfaces for reflecting said light beam, said reflecting surfaces being angularly variable depending on said image data.

28. An apparatus according to claim 24, further comprising mask data changing means (100) for changing the mask data set with respect to each of said recording component groups arrayed in a direction perpendicular to a scanning direction of said image recording medium (F), depending on the movement of a recording position with respect to a scanning direction of said image recording medium (F) while maintaining the number of recording components.

29. An apparatus according to claim 24, wherein defective recording components (40) are preferentially selected as said particular recording components (40).

30. An apparatus for recording an image on an image recording medium (F) by controlling a plurality of recording components (40) depending on image data, comprising:
locality characteristic data acquiring means (87) for acquiring locality characteristic data of recording characteristics due to said recording components (40);
particular recording component setting means (86) for setting particular recording components (40) to be controlled into an off-state in order to correct said locality characteristic data; and
recording component control means (42) for controlling the recording components (40) which are not to be controlled into an off-state depending on the image data to record the image on said image recording medium (F);
wherein said particular recording component setting means (86) preferentially selects and sets defective recording components (40) as said particular recording components (40).

31. An apparatus for recording an image on an image recording medium (F) by controlling a plurality of recording components (40) depending on image data, comprising:
locality characteristic data acquiring means (87) for acquiring locality characteristic data of recording characteristics due to said recording components (40);
particular recording component setting means (86) for setting particular recording components (40) to be controlled into an off-state in order to correct said locality characteristic data;
particular recording component switching means (100) for switching from said particular recording components (40) to other recording components depending on the movement of a recording position with respect to a scanning direction of said image recording medium (F); and
recording component control means (42) for controlling the recording components (40) which are not to be controlled into an off-state depending on the image data to record the image on said image recording medium (F).
